(19) United States
(12) Patent Application Publication
(10) Pub. No.: US 2008/0083515 A1
(43) Pub. Date: Apr. 10, 2008

(54) Overhead door track system

(75) Inventor: William B. Barnhart, Archbold, OH (US)

Correspondence Address: MARSHALL & MELHORN, LLC, FOUR SEAGATE - EIGHTH FLOOR, TOLEDO, OH, 43604, US

(73) Assignee: ARROW TRU-LINE, INC.

(21) Appl. No.: 11/522,734

(22) Filed: Sep. 18, 2006

(51) Int. Cl. E05D 15/00

(52) U.S. Cl. 160/201

(57) ABSTRACT

An overhead door track system has a roller stop integrally formed with a track member to prevent the rollers of an overhead door from moving off the track. A back hang angle is secured to the horizontal track member forward of the roller stop.

### FIELD OF THE INVENTION

The present invention relates to overhead door track systems and more particularly to a roller stop for such systems.

### BACKGROUND OF THE INVENTION

Tracks for the rollers of an overhead door to move within are well-known. The tracks typically comprise a vertical track connected to a horizontal track. Rollers that are secured to an overhead door ride in a roller channel defined by the vertical and horizontal tracks to permit the overhead door to go from a closed, vertical position to an open, horizontal position.

The horizontal track is typically suspended from the ceiling by one or more brackets or angles. Prior art tracks usually locate a bracket at the rear edge of the horizontal track and use the same mechanical fasteners used to secure the bracket to the track to also act as a roller stop. In other words, one or more mechanical fasteners that connect the bracket to the track extend into the roller channel to prevent the rollers from moving off the end of the horizontal track.

Economies of scale dictate that it is preferable to use the same, stock horizontal and vertical tracks for a variety of overhead doors and that the horizontal tracks are secured to the ceiling in the same manner with the same hardware. However, a bracket located at the rear edge of the horizontal track is not necessarily the optimal load carrying position for all overhead doors. Therefore, it would be advantageous to have an overhead door track system that is easily adaptable to a wide variety of applications. The track system must also prevent the door from moving off the horizontal track when the door is opened.

### SUMMARY OF THE INVENTION

The present invention is directed toward an overhead door track system having a horizontal track member, a roller stop and a back hang angle. The horizontal track member has a forward end, a back end and a roller channel extending between the ends. The roller stop is integrally formed with the track member and it extends into the roller channel adjacent the back end of the track member. The back hang angle is secured to the horizontal track member forward of the roller stop.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a schematic, perspective view of one embodiment of an overhead door track system of the present invention;

FIG. 2 is a schematic, perspective view of one embodiment of one component of the overhead door track system depicted in FIG. 1; and

FIG. 3 is a schematic, perspective view of another embodiment of one component of the overhead door track system depicted in FIG. 1.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

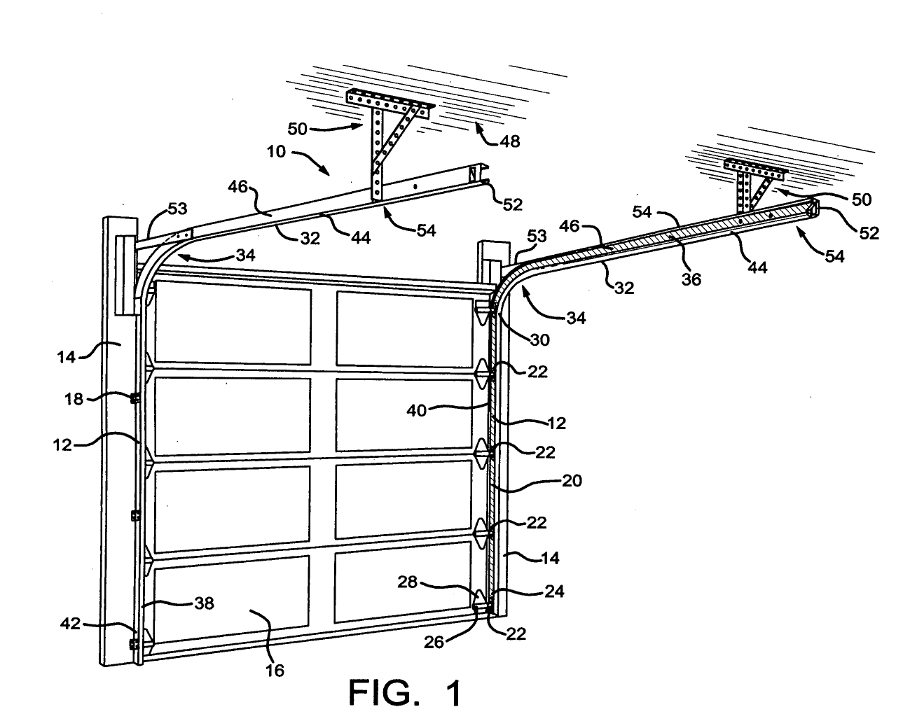

Referring now to FIG. 1, a preferred embodiment of an overhead door track system 10 is depicted. The system 10 comprises at least one substantially vertical track 12 that is anchored to an overhead door frame 14. The overhead door frame 14 defines an opening that is selectively closed by an overhead door 16. Preferably, two vertical tracks 12 are secured to the overhead door frame 14 along either side of the opening. A plurality of brackets 18 and mechanical fasteners are preferably used to anchor the vertical tracks 12 to the frame 14.

The vertical track 12 may be a single length of material or it may be comprised of multiple links that have been joined together. Regardless of the number of lengths of material comprising the vertical track 12, the track 12 preferably defines a continuous roller channel 20. While a C-shaped roller channel 20 will be described and depicted in the figures, it must be appreciated that the vertical track 12, as well as other track members discussed below, are not limited to C-shaped roller channels 20. By way of example only, the roller channel 20 may be L-shaped, U-shaped or V-shaped. Preferably, the vertical track 12 is oriented so that the C-shape opens toward the overhead door 16, as shown in FIG. 1.

The roller channel 20 accepts and guides a plurality of rollers 22 that are attached to the overhead door 16. Typically, each roller 22 comprises at least one wheel 24 mounted on a shaft 26. The shaft 26 is rotatably mounted within a hinge 28 on the overhead door 16. The hinge 28 is typically located at the intersection of each of the panels of the overhead door 16.

One roller of the plurality rollers 22 will be located above the other rollers in the vertical track 12 when the overhead door 16 is in the closed or vertical position. This roller will be designated the uppermost roller 30 herein.

The present invention also comprises a forward end of a horizontal track 32 connected to the vertical track 12. The two tracks 12, 32 may be connected together by a curved track portion 34 that is separately attached to the horizontal track 32 and the vertical track 12.

Alternatively, the curved track portion 34 may also be integrally formed with either the horizontal track 32 or the vertical track 12. It can be readily appreciated that if the curved track portion 34 is integrally formed with the horizontal track 32, then it is connected to the vertical track 12. If the curved track portion 34 is integrally formed with the vertical track 12, then it is connected to the horizontal track 32.

Regardless of how the horizontal and vertical tracks 12, 32 are connected, it is preferred that the roller channel 20 of the vertical track 12 is connected to a roller channel 36 of the horizontal track 32 so that the rollers 22 can move without interruption from channel 20 to channel 36 through the curved track portion 34.

The horizontal track 32 may be a single length of material or it may be comprised of multiple links that have been joined together. Regardless of the number of lengths of material used for the track 32, it is preferred the roller channel 36 is continuous.

In the preferred embodiment of the invention, the vertical track 12 and the horizontal track 32 on either side of the opening are substantially identical to one another. Additionally, both vertical tracks 12 are secured to the overhead door frame 14 in substantially the same manner using substantially the same type of brackets 18 and mechanical fasteners. Thus, for clarity and conciseness, only one side of the overhead door track system 10 will be discussed below. Reference numbers for features discussed below have been applied to like features on both sides of the system 10 in the figures where possible.

Preferably, the roller channel 36 of the horizontal track 32 has a substantially similar, if not identical, shape to the roller channel 20 of the vertical track 12. For example, if the vertical track 12 utilizes a C-shaped roller channel 20 that faces toward the overhead door 16, then it is preferred that the horizontal track 32 also uses a C-shaped channel 36 that faces toward the overhead door 16.

It should be appreciated, however, that the present invention is not limited to horizontal and vertical tracks 12, 32 that are similarly shaped. Those skilled in the art appreciate that it is helpful for the vertical track 12 to have at least a front surface 38, a back surface 40 and an outer side surface 42 to guide the rollers as the overhead door 16 is raised or lowered in the vertical track 12.

Once the overhead door 16 begins to transition from a substantially vertical orientation to a substantially horizontal orientation, the rollers 22 preferably need support along a lower surface 44 and an outer side surface 46 of the horizontal track 32. Those skilled in the art will appreciate that a multitude of combinations of vertical and horizontal track designs are possible with the present invention.

The horizontal track 32 is typically suspended from a ceiling 48 or framing member above the overhead door 16. As shown in FIG. 1, a multi-piece hanger 50, or back hang angle, is secured at one end to the ceiling 48 and the other end of the hanger 50 is secured to the horizontal track 32. The hanger 50 of FIG. 1 is provided for illustrative purposes and other hangers having any number of pieces in any design are within the scope of the present invention. Preferably, the hanger 50 is secured to the track 32 forward of an end 52 of the track 32.

Locating the hanger 50 forward of the end 52 of the horizontal track 32 permits the track 32, possibly supported by other hangers or supports (not shown), to carry greater loads along its length using a lighter weight track 32. The same horizontal track 32, being able to support greater loads, can now carry many different overhead doors 16.

One of the additional other supports mentioned above, may be such as a substantially horizontally oriented bracket 53 that extends from the frame 14 to the track 32 or the track portion 34. This bracket may be shorter than typically provided because the hanger 50 is located forward from the end 52 on the track 32, thus reducing the distance between support points for the track 32. Employing a bracket 53 shorter than required in the prior art functions as a cost savings for the invention.

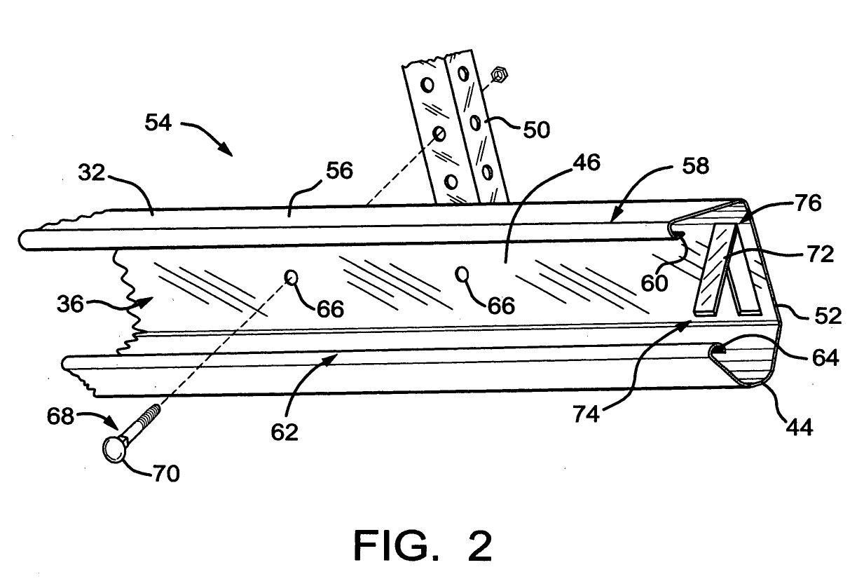

Turning now to FIG. 2, a preferred embodiment of an end portion 54 of the horizontal track 32 is depicted. In this embodiment, a roller channel 36 defined by the outer side surface 46, an upper surface 56 and the lower surface 44 of the horizontal track 32 is provided.

As shown in FIG. 2, the upper surface 56 is substantially planar. An inner portion 58 of the upper surface 56 has an inwardly turned lip 60. The lower surface 44 of the track 32 is curvilinear. The lower surface 44 has an inner portion 62 with an inwardly turned lip 64. The upper surface 56 and the lower surface 44 are preferably integrally formed with the outer side surface 46, which is substantially planar. The lip 60 of the upper surface 56 and the lip 64 of the lower surface 44 assist in maintaining the rollers 22 within the roller channel 36.

The outer side surface 46 contains one or more apertures 66. The apertures receive mechanical fasteners 68, such as bolts and/or screws, that secure the horizontal track 32 to the hanger 50. Regardless of whether bolts or screws are used, it is preferred that the head 70 of the mechanical fastener 68 is on the roller channel side of the outer side surface 46 and the shaft of the mechanical fastener 68 extends through the aperture 66 away from the roller channel 36. It can be appreciated that if the shaft of a mechanical fastener 68 is located into the roller channel 36, it could block the roller channel 36 and prevent the rollers 22 from moving past it.

Adjacent the end 52 of the horizontal track 32, and rearward of the hanger 50, a roller stop 72 that is integrally formed with the track 32 is provided. The roller stop 72 extends into the roller channel 36 to prevent the rollers 22, and in particular the uppermost roller 30, from moving off the end 52 of the horizontal track 32. The portion of the roller stop 72 that extends into the roller channel 30 is a channel portion 74 and the portion of the roller stop 72 that secures the roller stop 72 to the roller channel 36 is an attachment portion 76.

In the embodiment of the roller stop 72 depicted in FIG. 2, the channel portion 74 is substantially rectangular. The roller stop 72, however, may be any length and it may extend into the roller channel 36 at any angle as long as it will engage at least the uppermost roller 30 and prevent it from moving beyond the roller stop 72.

The roller stop 72 is preferably created by stamping the desired shape of the roller stop 72 out of the track 32. Other means, however, of creating the roller stop 72 are within the scope of the present invention. Such means may include, but are not limited to, cutting torches, water jets, lasers and/or mechanical saws.

The roller stop 72 depicted in FIG. 2 is merely one preferred embodiment of the present invention. The present invention is not limited to the shape or location of the roller stop 72 depicted in FIG. 2. It is within the scope of the present invention for the roller stop 72 to be curvilinear, such as oval or circular, and/or it may be multi-sided, such as triangular, or any other polygon.

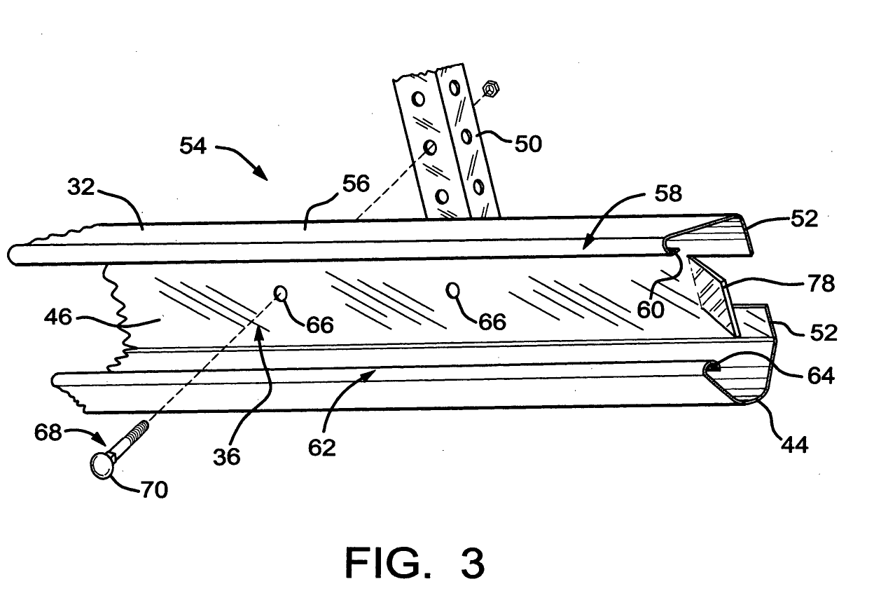

The present invention also comprises a roller stop 78 being formed from the end 52, or rear edge, of the track 32, as shown in FIG. 3. The roller stop 78 of FIG. 3 is depicted as being square, however, it can be any shape as discussed above. Additionally, while FIG. 3 depicts the roller stop 78 being located in the outer side surface 46 of the track 32, the roller stop 78 may also be located in the upper surface 56 or the lower surface 44 of the track 32.

It is also within the scope of the present invention for more than one roller stop 72, 78 to extend into the roller channel 36. For example, a roller stop 72, 78 may be located in the outer side surface 46 of the track 32 and the upper surface 56 or lower surface 44 so that the stops engage the uppermost roller 30 at the same time.

Preferably, the roller stop 72, 78 is selectively deflectable into the roller channel 36. For example, the roller stop 72, 78 may be initially stamped from the horizontal track 32 but not deflected into the roller channel 36 so that multiple horizontal and vertical tracks 12, 32 can be nested within one another for storage or transport. Once the track 32 is ready to be installed, an installer can use his or her hands and/or a hand tool, to deflect the roller stop 72, 78 into the roller channel 36.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. An overhead door track system, comprising:
a horizontal track member having a forward end, a back end and a roller channel extending between said ends;
a roller stop integrally formed from said track member adjacent said back end, said roller stop extending into said roller channel; and
a back hang angle secured to said horizontal track member forward of said roller stop.

2. The system of claim 1, wherein an overhead door is movable along said track member by a plurality of rollers attached to said door and located in said roller channel, said rollers being prevented from moving past said back end of said track by said roller stop.

3. The system of claim 1, wherein a portion of said roller stop is deformable permitting said roller stop to be selectively located in said wheel channel.

4. The system of claim 1, wherein said roller stop is stamped from said track member.

5. The system of claim 1, wherein said roller stop is formed from a back edge of said horizontal track member.

6. An overhead door track system, comprising:
a horizontal track member having a forward end, a back end and a roller channel extending between said ends;
a roller stop having a channel portion extending into said roller channel and an attachment portion integrally formed with said track member; and
a back hang angle secured to said horizontal track member forward of said roller stop.

7. An overhead door track system, comprising:
a roller channel extending continuously between a horizontal track member, and a vertical track member and a curved track member;
an overhead door having a plurality of rollers located in said roller channel to permit said door to move from a substantially vertical position to a substantially horizontal position;
a roller stop integrally formed with said horizontal track member, said roller stop being selectively deformed into said roller channel to stop an uppermost roller on said door from traveling beyond a predetermined point in said horizontal track member; and
a back hang angle secured to said horizontal track member forward of said roller stop.
